(19) United States
(12) Patent Application Publication
(10) Pub. No.: US 2008/0052267 A1
(43) Pub. Date: Feb. 28, 2008

(54) REPLAY DEVICE

(75) Inventor: Kazuki HAYASHIBARA, Osaka (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/843,955

(22) Filed: Aug. 23, 2007

(30) Foreign Application Priority Data
Aug. 28, 2006 (JP) 2006-230782

(51) Int. Cl. G06F 17/30

(52) U.S. Cl. 707/2; 707/E17.005

(57) ABSTRACT

This replay device includes a replay means which reads in and replays a designated file from a medium upon which a folder is recorded. Moreover, this replay device includes a selection means which receives selection, from contents recorded upon said medium, of said folder which is to be replayed. And the replay device also includes a control means which, when the folder is selected by the selection means, commands said replay means to read in, from said medium, an audio file and a still image file stored in said folder selected by said selection means. And the replay means replays said audio file and said still image file which have been read in, simultaneously.

### CROSS REFERENCE

This Nonprovisional application claims priority under 35 U.S.C. § 119(a) on Patent Application No. 2006-230782 filed in Japan on Aug. 28, 2006, the entire contents of which are hereby incorporated by reference.

### BACKGROUND OF THE INVENTION

The present invention relates to a replay device which reads and replays audio files and still image files from a medium upon which those files are recorded.

In the prior art, replay devices have been implemented in practice and have become generally widespread, which replay still image files such as photographs and the like, and audio files such as music and the like, recorded upon media.

In order to confirm to the user the contents which are recorded upon a medium, before replaying the above described files, such a replay device displays the recorded contents. The user looks at this display, and selects from the recorded contents the file or files which he desires. This selection is performed with an actuation section which is provided to the replay device. And the replay device replays the files which are selected.

By doing this, replay of the selected files is performed by the replay device. At this time, the replay device is able to play back sound based upon an audio file while simultaneously displaying a still image based upon a still image file.

It should be understood that a device which records audio files and still image files upon a medium in mutual correspondence has been proposed in Japanese Laid-Open Patent Publication Heisei 9-238303.

However, with the above described prior art replay device, if the user considers that he desires to replay an audio file and a still image file at the same time, he must select the audio file and the still image file one at a time. Due to this, the user has been compelled to, for example, select the still image file after having selected the audio file.

Accordingly, with a prior art type replay device, when the user wants to replay an audio file and a still image file at the same time, he has been burdened with the task of being required to select these two files individually, one after the other.

Furthermore, with the device proposed in the above Japanese Laid-Open Patent Publication Heisei 9-238303, even if the user wants to replay an audio file and a still image file simultaneously immediately after he has completed recording them, he is still obliged to select the audio file and the still image file one at a time.

The object of the present invention is to provide a replay device with which the number of actuations needed for replaying audio and a still image simultaneously is reduced, so that the convenience of use by the user is enhanced.

### SUMMARY OF THE INVENTION

The replay device according to the present invention includes a replay means which reads in and replays a designated file from a medium upon which is recorded a folder. With this structure the medium may be, for example, a hard disk or an optical disk. Both audio files and still image files are stored in this folder. The still images are, for example, photographs or drawings.

Furthermore, this replay device includes a selection means which receives selection, from contents recorded upon said medium, of a folder which is to be replayed. And, in order for the user to check the contents recorded upon the medium, this replay device displays the recorded contents before replaying the above described files. The user looks at this display, and selects with the selection means, from the recorded contents, the folder which he desires.

Moreover, the replay device includes a control means which, when a folder is selected with the selection means, commands the replay means to read in the audio files and the still image files which are stored in the selected folder. And the replay means replays the read in audio files and still image files simultaneously. By doing this, audio based upon the audio files and images based upon the still image files are replayed at the same time.

### BRIEF DESCRIPTION OF THE DRAWINGS

FIG. 1 is a block diagram showing the main structure of an optical disk device which is an embodiment of the present invention;

FIG. 2 is a figure showing a recording region upon an optical disk 100;

FIG. 3 is a figure showing contents recorded upon the optical disk 100;

FIG. 4 is a flow chart showing operations performed by a control unit of an optical disk device which is an embodiment of the present invention;

FIG. 5 is a figure showing a screen of a display unit 9, upon which contents recorded upon an optical disk 100 are displayed;

FIG. 6 is a flow chart showing operations performed by a control unit of an optical disk device which is a first variant embodiment of the present invention; and

FIG. 7 is a time chart showing relationship between replayed image files and audio files.

FIG. 8 is a flow chart showing operations performed by a control unit of an optical disk device which is a second variant embodiment of the present invention.

### DETAILED DESCRIPTION OF THE INVENTION

In the following, an optical disk device which is an embodiment of the present invention will be explained with reference to the drawings.

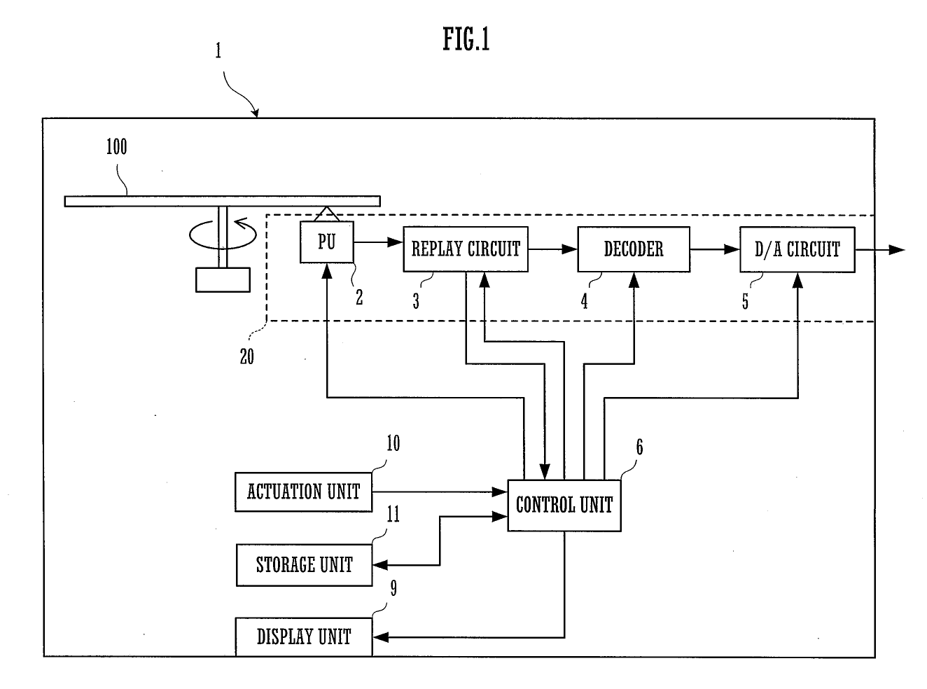

FIG. 1 is a block diagram showing the main structure of an optical disk device which is an embodiment of the present invention. This optical disk device 1 comprises a pickup head 2 (hereinafter termed the “PU head 2”) which performs reading of data from an optical disk 100 which is loaded into the optical disk device 1, a replay circuit 3 which comprises a RF amp and the like, a decoder 4 which decodes data, a D/A circuit 5 which D/A converts data, a control unit 6 which controls the various sections of this optical disk device 1, a display unit 9 which displays information, an actuation unit 10 which receives actuation by the user, and a storage unit 11 which stores data. This optical disk device 1 is a so called DVD player. Furthermore, the optical disk 100 may be a CD, a Blu-ray disk, or a DVD.

It should be understood that although, in this embodiment, the present invention is explained in terms of a DVD player as being an example of an optical device, this is not intended to be limitative; when implemented, the present invention could also be a DVD recorder or the like, provided that it is endowed with a replay function.

The PU head 2 comprises a laser diode (LD), a collimator lens, a beam splitter, an objective lens, a photodetector, a thread motor, and an actuator, none of which are shown in the figures.

This PU head 2 is fitted upon a shaft which extends in the radial direction of the optical disk 100, so as to be able to shift freely thereupon. And the thread motor shifts the PU head 2 in the radial direction of the optical disk 100.

The LD is a light source which outputs laser light. And the photodetector comprises a plurality of light reception elements, and detects light reflected from the optical disk 100.

During replay, the PU head 2 irradiates laser light of reading power upon the optical disk 100, and detects the light reflected from the optical disk 100 with the photodetector. Due to this, the data which is recorded upon the optical disk 100 is optically read in.

The replay circuit 3 generates and amplifies an RF signal based upon the outputs of the plurality of light reception elements of the PU head 2, and processes this RF signal and extracts audio data and/or still image data therefrom. Here, the data which is extracted is encoded, for example, according to the mp3 (MPEG Audio Layer—3) or the JPEG (Joint Photographic Experts Group) standard. And the extracted data is temporarily stored in a buffer RAM, not shown in the figures, which is internal to the replay circuit 3.

The data which is stored in this buffer RAM is read in sequentially according to read in requests from the control unit 6, and is transferred (outputted) to the decoder 4.

The decoder 4 decodes the data which is being stored in the buffer RAM. This decoded data, after having been temporarily stored in a decoder RAM (not shown in the figures), is read in again, and is sequentially transferred to the D/A circuit 5.

The D/A circuit 5 converts the image data, which has been expanded by the decoder 4, into an analog image replay signal. Furthermore, the D/A circuit 5 converts the audio data, which has been expanded by the decoder 4, into an analog audio replay signal. And the D/A circuit 5 outputs these two analog signals to the exterior of the optical disk device 1. Due to this, the user is able to view a still image based upon the image replay signal which has thus been outputted from the D/A circuit 5, and to listen to sound based upon the outputted audio replay signal, upon a television or the like (not shown in the figures) which is connected to this optical disk device 1.

The storage unit 11 comprises, for example, a semiconductor memory or a hard disk or the like. Such a semiconductor memory may be, for example, an EEPROM.

The actuation unit 10 comprises a plurality of actuation keys (not shown in the figures) upon which the user performs actuation for input to the optical disk device 1, and a remote control reception unit (likewise not shown in the figures) which receives commands for the optical disk device 1 which have been transmitted from a remote control unit (also not shown in the figures). This actuation unit 10 transmits to the control unit 6 commands which correspond to the actuation keys which have been actuated by the user, and commands which it has received via the remote control reception unit.

In the plurality of actuation keys described above, there are included a folder selection key for selecting, from the contents recorded upon the optical disk 100, a desired folder for replay of some file therein, and a file selection key for selecting, from the contents of a selected folder recorded upon the optical disk 100, a desired file for replay.

It should be understood that the actuation unit 10 corresponds to the “selection means” of the Claims.

The display unit 9 may comprise, for example, a liquid crystal panel. And this display unit 9 displays the current time instant, the setting state of the optical disk device 1, and so on.

The control unit 6 may comprise, for example, a microcomputer. Furthermore, this control unit 6 comprises a ROM (not shown in the figures) which stores a control program, and a RAM (not shown in the figures either) which serves as a work space for deployment of data processed by this control program.

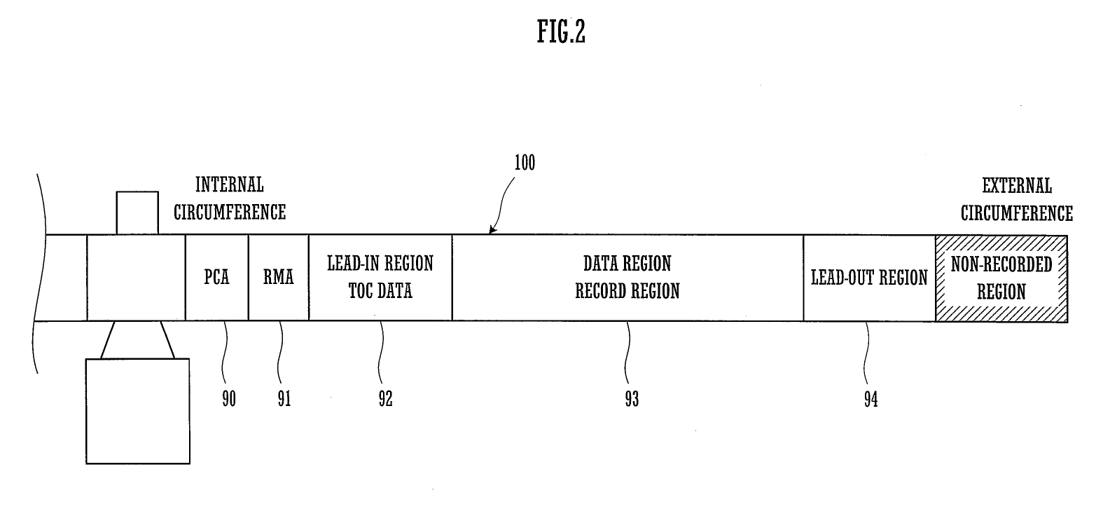

FIG. 2 is a figure showing the recording region upon the optical disk 100. From its internal circumference towards its external circumference, the recording region upon the optical disk 100 is divided into a PCA 90, a RMA 91, a lead-in region 92, a data region 93, and a lead-out region 94.

The PCA 90 is a region upon which proofing of the laser power is performed. Furthermore, the RMA 91 is a region in which record management information, necessary for the operation of the optical disk device 1, is recorded.

It should be understood that, if the optical disk 100 is a play-only optical disk, then the PCA 90 and the RMA 91 are not present.

The lead-in region 92 is a region upon the optical disk 100 in which is recorded TOC data for the data recorded in the data region 93. In this TOC data, there are included information as to whether or not the stored data is finalized, the date upon which the data was stored, title information for the stored data, and address information upon the optical disk and the like for the stored data.

The data region 93 is a region in which the stored data is recorded.

The lead-out region 94 is a region which is created when the stored data is finalized. This finalization is a process for arranging the recorded information in order to make it compatible with other optical disk devices. By performing such finalization, it becomes possible to replay the optical disk 100 upon other optical disk devices.

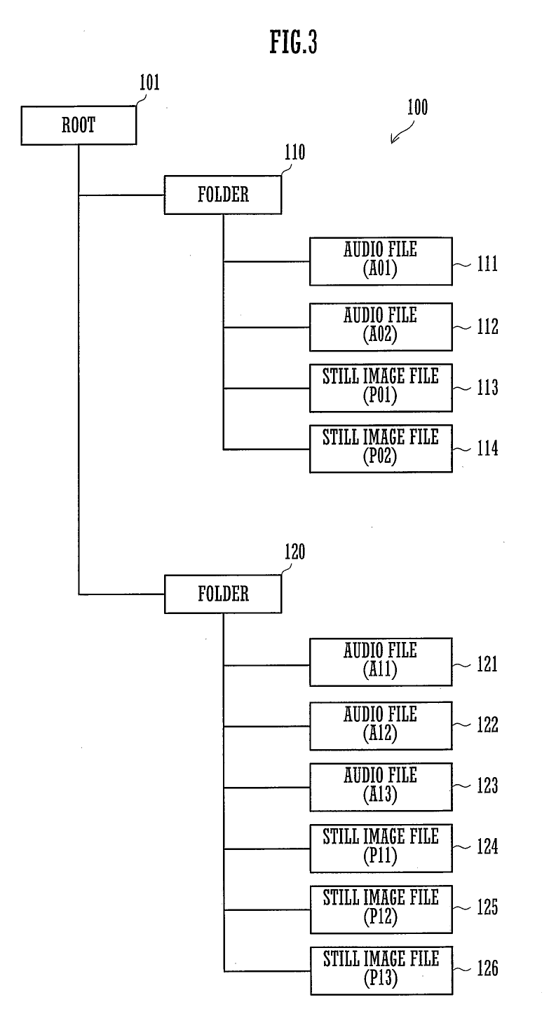

FIG. 3 is a figure showing contents recorded upon the optical disk 100. On this optical disk 100 there are recorded folders 110 and 120, in which audio files and still image files are stored. Audio files 111 and 112 and still image files 113 and 114 are stored in the folder 110. And audio files 121, 122 and 123 and still image files 124, 125 and 126 are stored in the folder 120.

In this embodiment, the file format of the audio files 111, 112, 121, 122 and 123 is the mp3 format. And the file format of the still image files 113, 114, 124, 125 and 126 is the JPEG format. Moreover, a replay sequence for replaying these files is described in advance, as follows. The file names of the audio files 111 and 112 are “A01” and “A02” respectively. Furthermore, the file names of the still image files 113 and 114 are “P01” and “P02” respectively. On the other hand, the file names of the audio files 121, 122 and 123 are “A11”, “A12” and “A13” respectively. Furthermore, the file names of the still image files 124, 125 and 126 are “P11”, “P12” and “P13” respectively.

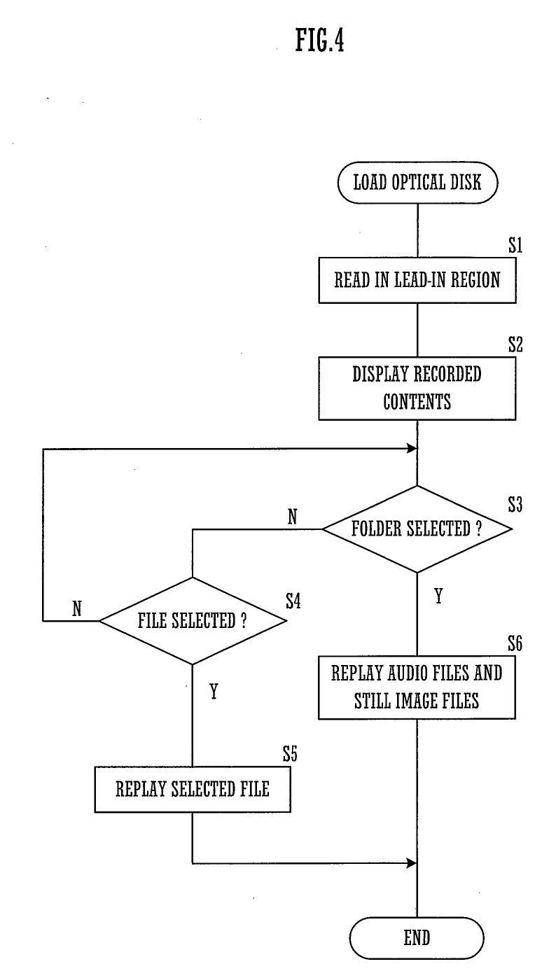

FIG. 4 is a flow chart showing operations performed by a control unit of this optical disk device 1 which is an embodiment of the present invention. These operations are performed when the optical disk 100 is loaded into the optical disk device 1.

When this optical disk 100 is loaded into the optical disk device 1, the control unit 6 commands the PU head 2 to read in the TOC data which is described in the lead-in region 92 of the disk 100 (a step S1). By doing this, the control unit 6 acquires the details of the contents recorded upon the optical disk 100, via the replay circuit 3.

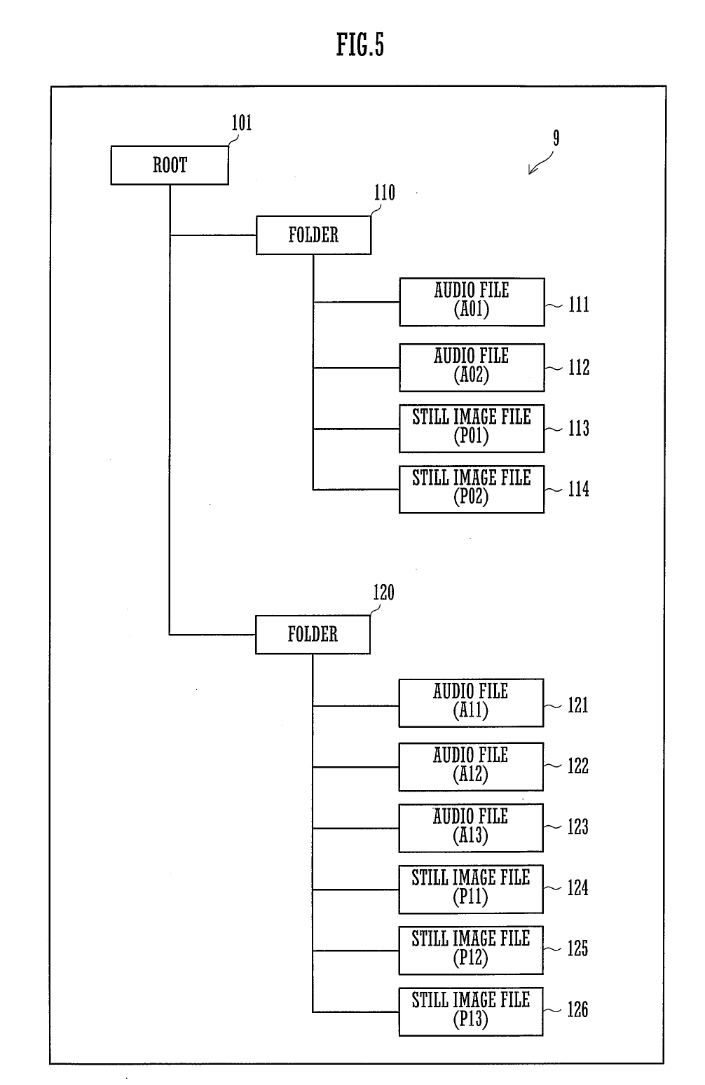

And the control unit 6 displays the recorded contents which have thus been acquired upon the display unit 9 (a step S2). Due to this, the recorded contents are displayed upon the display unit 9, as for example shown in FIG. 5. The user is able to look at this display and to check the contents which are recorded upon the optical disk 100.

FIG. 5 is a figure showing the screen of the display unit 9, when the contents recorded upon the optical disk 100 are being displayed thereupon.

The control unit 6 decides (a step S3) whether or not a folder in which audio files and still image files are stored has been selected. If, in FIG. 5, either one of the folders 110 and 120 is being selected with the folder selection key, then the result of this decision is affirmative.

If it is decided that such a folder as described above is not being selected, then the control unit 6 makes a decision as to whether or not a file has been selected (a step S4). If, in FIG. 5, any one of the files 111 through 114 or 121 through 126 is being selected with the file selection key, then the result of this decision is affirmative.

Here, the steps S3 and S4 constitute a mechanism via which the user can select whether or not to perform replay as described hereinafter with reference to a step S6, or to perform normal replay as in a subsequent step S5.

And, if a file has been selected, the control unit 6 starts replay of the selected file (a step S5), and then this processing terminates. Due to this, the rep lay unit 20 starts normal replay operation. The replay unit 20 consists of the PU head 2, the replay circuit 3, the decoder 4, and the D/A circuit 5.

On the other hand, if one of the above described folders has been selected, then the control unit 6 starts replay of the audio files and the still image files which are stored in this folder (a step S6). And the control unit 6 then terminates this processing. Due to this, the above described replay unit 20 replays the audio files and the still image files. At this time, the control unit 6 refers to the file names of the audio files and the still image files which are stored in this folder, and issues commands to the replay unit 20 to replay them in order from those which include the smallest numerals. For example, if the folder 110 in FIG. 3 is selected, then, according to this sequence for replay, the audio file 111 and the still image file 113 will be replayed simultaneously. And, when the replay of the audio file 111 ends, the replay process then switches to replaying the audio file 112 and the image file 114 simultaneously. In a similar way, if the folder 120 is selected, then, according to this sequence for replay, the replay will be performed simultaneously from the audio file 121 and the still image file 124. And, when the replay of the audio file 121 terminates, the replay process then switches to replaying the audio file 122 and the image file 125 simultaneously. Finally, when the replay of the audio file 122 terminates, the replay process then switches to replaying the audio file 123 and the image file 126 simultaneously.

By the above, simply by the user selecting a folder in which both one or more audio files and one or more still image files are stored, the audio and the still images are replayed simultaneously. In other words, with one single actuation, the user is able to replay the audio files and the still image files at the same time. Accordingly, the convenience of use from the point of view of the user is enhanced.

Furthermore, the following variant embodiments of the above embodiment of the present invention may be implemented.

### A FIRST VARIANT EMBODIMENT

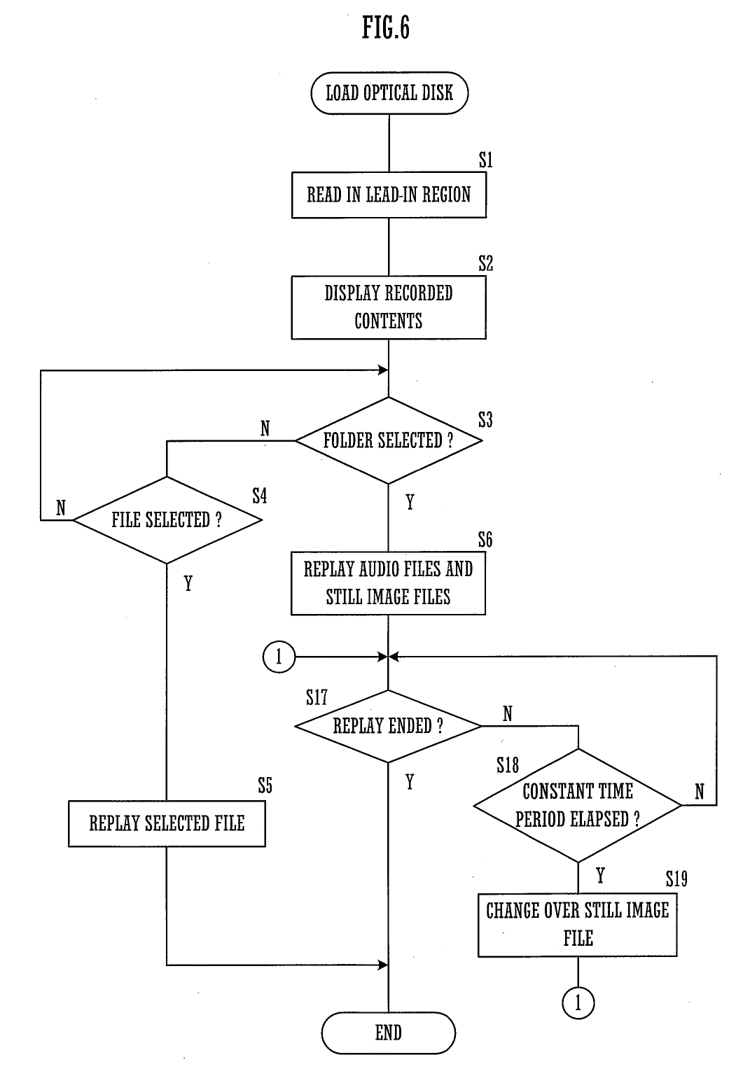

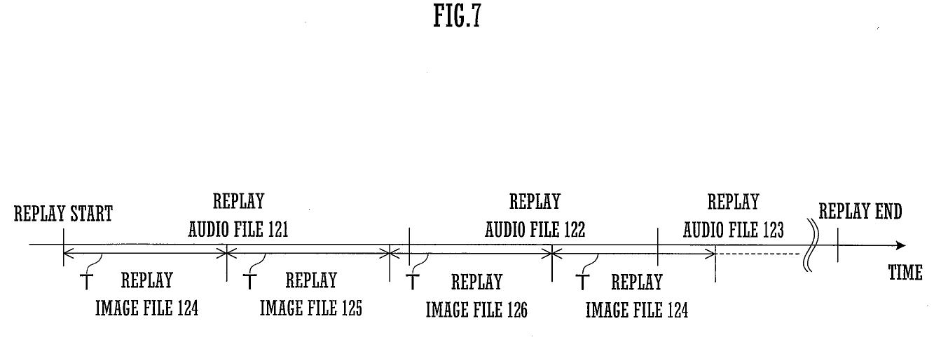

FIG. 6 is a flow chart showing operations performed by a control unit of an optical disk device which is a first variant embodiment of the present invention. Among these operations, the steps S17 through S19 are ones which are appended after the processing of the step S6 shown in FIG. 4, and the other operations (the steps S1 through S6) are the same as in the above embodiment. And, FIG. 7 is a time chart showing relationship between replayed image files and audio files.

During replay of a folder (a negative decision in the step S17), each time a constant time period elapses (the step S18), the control unit 6 commands the PU head 2 to change over the still image file and read in another (the step S19). This fixed time period may be, for example, 30 seconds. Here, in order to perform the step S18, the control unit 6 is equipped with a timer circuit (not shown in the figures) which measures the constant time period.

It should be understood that the control unit 6 reaches a negative decision in the step S17, if some unread audio file is still present in the folder which is selected.

And, when all of the audio files within the selected folder have been read in by the PU head 2 and replay thereof has been completed (Y in the step S17, then the control unit 6 terminates this processing).

In other words, in the steps S17 through S19, while replaying the audio files, the replay unit 20 changes over the still image file which is being replayed at fixed time intervals. For example, in FIG. 3, while the replay unit 20 is reading in and replaying the audio file 121, the PU head 2 changes over the still image file which it reads at fixed time T intervals in the order of the files 124, 125, and 126 (shown in FIG. 7). Moreover, while reading in and replaying the audio files 122 and 123 as well, the PU head 2 changes over the still image files in a similar manner (shown in FIG. 7).

According to the above, only by selecting a folder in which audio files and still image files are stored, the audio and still images therein may be replayed simultaneously. Furthermore, while replaying the audio, the still images are changed over at fixed intervals. In other words, with a single actuation, the user is able to replay the audio while changing over the still images. Accordingly, the ease of use from the point of view of the user is enhanced by yet a further level.

### A SECOND VARIANT EMBODIMENT

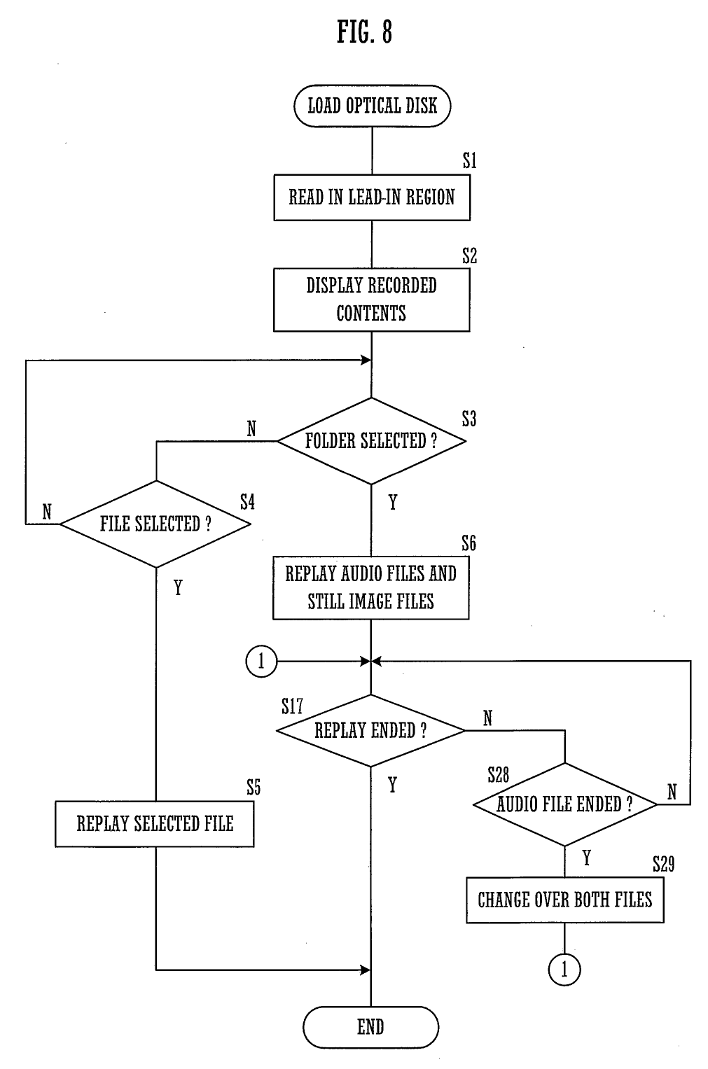

FIG. 8 is a flow chart showing operations performed by a control unit of an optical disk device which is a second variant embodiment of the present invention. Among these operations, the steps S28 and S29 are ones which replace the steps S18 and S19 of FIG. 6, and the other operations (the steps S1 through S6 and the step S17) are the same as in the above first variant embodiment.

In this case, the control unit 6 decides, from the file names shown in FIG. 3, that the audio files 111 and 112 and the image files 113 and 114 are stored in respective one-to-one correspondence. In a similar manner, the control unit 6 decides from the file names that the audio files 121, 122 and 123 and the image files 124, 125 and 126 are stored in respective one-to-one correspondence. In more detail, for example, in the folder 120, since the numeric portions of the audio file 121 and the still image file 124 are the same, both being “11”, these two files constitute a pair.

And, each time during the replay of a folder (a negative decision in the step S17) that the replay of a single audio file terminates (the step S28), the control unit 6 issues a command to the PU head 2 to change over the audio file which is being read in and also the still image file (a step S29). Due to this, along with reading in and replaying the plurality of audio files one file at a time, the replay unit 20 reads in and replays that still image file which corresponds to the audio file which is being replayed. For example, when replaying the audio file 121, the replay unit 20 reads in and replays the still image file 124 which corresponds to that audio file 121 (refer to FIG. 3).

According to the above, only by selecting a folder in which audio files and still image files are stored, the audio and still images therein may be replayed simultaneously. Furthermore, while replaying each audio file, the still image which corresponds to that audio file is replayed. In other words, with a single actuation, the user is able to replay the audio and still images while changing them over in a synchronized manner. Accordingly, it is possible to enhance the ease of use from the point of view of the user by yet a further level.

What is claimed is:

1. A replay device, comprising:
a replay means which reads in and replays a designated file from a medium upon which is recorded a folder in which one or more audio files and one or more still image files are stored together;
a selection means which receives selection, from contents recorded upon said medium, of said folder which is to be replayed; and
a control means which commands said replay means to read in, from said medium, one of said one or more audio files and one of said one or more still image files which are stored in said folder selected by said selection means;
and wherein said replay means replays said one of said one or more audio files and said one of said one or more still image files which have been read in, simultaneously.

2. A replay device as described in claim 1, wherein:
a replay sequence for said audio files and for said still image files is described in advance in their file names; and
said control means commands said replay means to replay in said audio files and said still image files, which are stored in said selected folder, from said medium according to said replay sequence.

3. A replay device as described in claim 1, wherein:
a plurality of still image files and at least a single audio file are stored in said folder; and
while said replay means is reading in and replaying said audio file, said control means commands said replay means to change over the still image file which is being replayed in at fixed time intervals.

4. A replay device as described in claim 1, wherein:
a plurality of still image files and a plurality of audio files are stored in said folder in one-to-one pairs; and
said control means commands said replay means to replay each said pair of a still image file and an audio file, together.

5. A replay device as described in claim 1, wherein said medium is an optical disk.
